(19) United States
(12) Patent Application Publication
(10) Pub. No.: US 2016/0325223 A1
(43) Pub. Date: Nov. 10, 2016

(54) SUBMARINE HAVING A CO2 BINDING UNIT

(71) Applicant: THYSSENKRUPP MARINE SYSTEMS GMBH, Kiel (DE)

(72) Inventor: Richard BÜCHNER, Bad Schwartau (DE)

(73) Assignee: ThyssenKrupp Marine Systems GmbH, Kiel (DE)

(21) Appl. No.: 15/035,768

(22) PCT Filed: Nov. 11, 2014
(86) PCT No.: PCT/EP2014/003014

§ 371 Date: May 11, 2016

(30) Foreign Application Priority Data
Nov. 15, 2013 (DE) 10 2013 223 342.6

(51) Int. Cl. B01D 53/04; B63G 8/00

(52) U.S. Cl. CPC B01D 53/0438; B63G 8/00; B01D 53/0446; B01D 2257/504; B01D 2259/4566

(57) ABSTRACT

A submarine may have a CO₂ binding unit for binding CO₂ of a CO₂ -containing gas mixture. The CO₂ binding unit may serve to bind CO₂ stemming from an interior of the submarine and contained in exhalation air of a crew. To this end, the CO₂ binding unit may include at least one adsorption tank having a gas inlet, a gas outlet, and at least one inner container filled or fillable with a CO₂ binding agent. The gas inlet may be connected to a duct extending into an interior of the inner container, while the gas outlet may be connected to a chamber that externally surrounds the inner container in the adsorption tank.

The invention relates to a submarine having a CO₂ binding unit for binding CO₂ of a CO₂ -containing gas mixture.

On submarines, it is necessary in dives below the snorkeling depth to keep the elevated (in particular as a result of the exhalation air of the crew) CO₂ component of the room air inside the submarine below an admissible limit value. To this end, CO₂ binding units are generally employed on board submarines.

CO₂ binding units of this kind, in which CO₂ is bound by a hydroxide and is thereupon converted into a carbonate, form part of the prior art. The hydroxide is located in adsorption tanks, which are flowed through by the interior air or ventilation air of the submarine. The adsorption capacity of the hydroxide is limited. The hydroxide must therefore be exchanged, at the latest once it has fully converted into carbonate. For this purpose, the hydroxide is filled into cartridges, which in the adsorption tanks of the CO₂ binding unit are exchanged at regular intervals. It here proves to be disadvantageous that the intervals at which the cartridges must be exchanged are comparatively short, so that these CO₂ binding units are relatively labor intensive, which may possibly interfere with the rest of the operation of the boat.

From DE 10 2008 015 150 B4, a CO₂ binding unit having a plurality of adsorption tanks which can be successively switched into a setting in which they can be flowed through by the ventilation air is known. The number of adsorption tanks is dimensioned such that the ventilation air of the submarine, during a complete mission of the submarine at sea, reliably adsorbs the CO₂ present in the air, in which case the cartridges of the adsorption tanks do not have to be exchanged.

An exchange of the cartridges present in the adsorption tanks is not necessary in the case of reversible CO₂ binding units. Thus DE 10 2006 048 716 B3 discloses a CO₂ binding unit which is used in conjunction with a regenerable CO₂ binding agent. For the regeneration of the CO₂ binding agent, the CO₂ binding unit is flowed through by water vapor, whereby the CO₂ is released from the binding agent and is subsequently drawn off from the CO₂ binding unit.

In addition, reversible CO2 binding units in which the bound CO₂ can be released again by the supply of heat are known. A CO₂ binding unit of this kind is described in US 2008/0202339 A1. This CO₂ binding unit has two adsorption tanks, of which, alternately, one binds the CO₂ present in the air, while the other is regenerated by the supply of heat. To this end, the two adsorption tanks are thermally interconnected, wherein heat is led off from the adsorption tank which is just now adsorbing into the adsorption tank which is to be regenerated.

Against this background, the object of the invention is to provide a submarine having an improved CO₂ binding unit.

This object is achieved by a submarine having the features defined in claim 1. Advantageous refinements of this submarine emerge from the subclaims, the following description and the drawing. Here, the features defined in the subclaims can respectively in their own right, but also in suitable combination with one another, further shape the inventive solution as claimed in claim 1.

The submarine according to the invention, which is preferably constituted by a military submarine, is equipped with a CO₂ binding unit for binding CO₂ of a CO₂-containing gas mixture. The CO₂ binding unit particularly serves to bind the CO₂ contained in the air inside the submarine. The CO₂ binding unit has at least one adsorption tank, comprising a gas inlet, a gas outlet and at least one inner container, which latter is filled with a CO₂ binding agent and at least in some regions is gas permeable. In particular when the CO₂ binding unit is constituted by a regenerative CO₂ binding unit in which the bound CO₂ can be released again, the CO₂ binding unit expediently has two or more parallelly operated adsorption tanks of this type, which enables a continuous operation of the CO₂ binding unit, since one adsorption tank is always in the adsorption cycle while another is simultaneously regenerated.

According to the invention, the gas inlet of the adsorption tank is connected to a duct leading into the interior of the inner container, and the gas outlet is connected to a chamber externally surrounding the inner container. The duct leading into the interior of the inner container expediently extends throughout the inner container, wherein it is arranged such that on the whole of its outer peripheral surface within the inner container it is surrounded by the CO₂ binding agent present in the inner container. Starting from the duct, the inner container can be flowed through transversely to the longitudinal extent of the duct. To this end, an outer side of the duct, which peripherally delimits the duct, is typically of gas permeable configuration, so that the gas can make its way from the duct into the CO₂ binding agent filling of the inner container. From there, the gas which is now freed from the CO₂ flows through the outer wall of the inner container into the chamber surrounding the inner container in the adsorption tank, whence it makes its way out of the adsorption tank via the gas outlet. In contrast to the previously known adsorption tanks, the inner container disposed in the adsorption tank according to the invention is flowed through from inside to out. This has the advantage that the flow velocity, when the CO₂ binding agent is flowed through on the outside of the duct, decreases with increasing distance to the duct and, correspondingly, the contact time of the CO₂ containing gas mixture with the CO₂ binding agent significantly lengthens, which results in a particularly effective removal of the CO₂ from the gas mixture. In this respect, the inventive design of the adsorption tank and of the cartridge present therein represents a significant improvement in process engineering terms.

If the CO₂ binding unit is constituted by an irreversible CO₂ binding unit, it is necessary to exchange the CO₂ binding agent present in the adsorption tank, once it has lost its adsorption capacity, for an adsorbent CO₂ binding agent. In this case, in particular, it proves to be advantageous if an interchangeable cartridge, which can be easily exchanged for another, forms the inner container. Where a regenerable CO₂ binding agent is used, the inner container, where appropriate, can be an integral component of the adsorption tank, though, in this case too, the use of an interchangeable cartridge as the inner container of the adsorption tank is preferable.

The CO₂ binding agent which is used in the adsorption tank of the CO₂ binding unit of the submarine according to the invention is preferably of thermally regenerable configuration. In this context, according to an advantageous refinement of the invention there is provided at least one elongate heating element, which leads through the CO₂ binding agent filling of the inner container and on the outer sides of which are disposed a plurality of mutually spaced heating fins. Through the use of the heating fins, the heat-emitting surface of the heating element is considerably enlarged, whereby the time which is necessary to heat the CO₂ binding agent, and consequently the time which is required to regenerate the CO₂ binding agent, are considerably shortened. Expediently, the heating element and the heating fins are arranged in the inner container such that they are embedded directly in the CO₂ binding agent. This is advantageous insofar as the direct contact of the CO₂ binding agent with the heating element and the heating fins promotes a rapid heating.

The arrangement, dimensioning and design of the heating element and of the heating fins are expediently chosen such that a homogeneous heating of the whole of the CO₂ binding agent present in the inner container is ensured. In this context, it is advantageously provided that the heating element is oriented parallel to the duct. Furthermore, it can also effectively be ensured that the heating fins form no barrier for the gas flowing through the CO₂ binding agent. In this context, it is advantageously provided that the heating fins are oriented parallel to the direction of flow through the inner container outside the duct. Hence the heating fins, which are preferably configured as thin disks, are preferredly oriented transversely to the longitudinal extent of the duct configured in the inner container.

Further advantageously, it is provided that the heating fins fully surround the duct configured in the inner container. Accordingly, the heating fins are preferably of annular configuration, wherein the duct runs through a preferably centrally configured aperture configured on the heating fin.

Further advantageously, a tube flowed through by a heating medium can form the heating element. In this embodiment, in the inner container of the adsorption tank, preferredly in the region filled with the CO₂ binding agent, is arranged at least one tube, which is flowed through by a heat carrier in the form of a liquid, e.g. water or a thermal oil, or in the form of a gas, e.g. steam. The tube is expediently formed of a material having good thermal conductivity, such as copper, and extends in the inner container preferably parallel to the duct configured in the inner container throughout the length of the inner container.

Alternatively, the heating element can also be part of an electrical resistance heating system. Thus an elongate heating rod, which is introduced into the CO₂ binding agent filling of the inner container and is heatable by means of electrical resistance heating, can form the heating element. Also, such a heating rod is expediently oriented and dimensioned such that it extends in the inner container, preferably parallel to the duct configured in the inner container, throughout the length of the inner container.

According to a further preferred embodiment of the CO₂ binding unit used in the submarine according to the invention, the inner container of the adsorption tank is cylindrically configured, wherein the duct, which is configured in the inner container and which expediently is also cylindrically configured, is guided centrally in the longitudinal direction of the inner container through this same and an annular chamber between the duct and a peripheral wall of the inner container is filled with the CO₂ binding agent. In this embodiment, the annular chamber between the duct and the peripheral wall of the inner container is flowed through in any chosen radial direction by the CO₂-containing gas mixture, wherein the flow path through the annular chamber is always equally long regardless of the flow direction.

In a refinement of this embodiment of the inner container, the heating fins disposed on the heating element advantageously have a cross section which corresponds with the inner cross section of the annular chamber filled with the CO2 binding agent. That is to say, the heating elements are preferably configured as annular disks, wherein these are dimensioned such that, when arranged in the annular chamber of the inner housing, they have only a small clearance relative to the duct, which internally delimits the annular chamber, and to the peripheral wall of the inner housing, which externally delimits the annular chamber.

In order to be able to provide quickly and in sufficient measure the thermal energy which is necessary to regenerate the CO₂ binding agent, on the thus designed heating fins there are advantageously configured two apertures, which preferably diametrically oppose each other and through which a heating element is respectively guided. Accordingly, the heating fins are respectively thermally connected to two heating elements. It should be pointed out that on the heating fins more than two apertures, with heating elements guided through these, can also, where appropriate, be provided. In this case, it is only important that they have the same distance apart on the heating fin in order to ensure good heat distribution.

The invention is explained in greater detail below on the basis of an illustrative embodiment represented in the drawing. In the drawing, respectively in schematically heavily simplified form and on different scales:

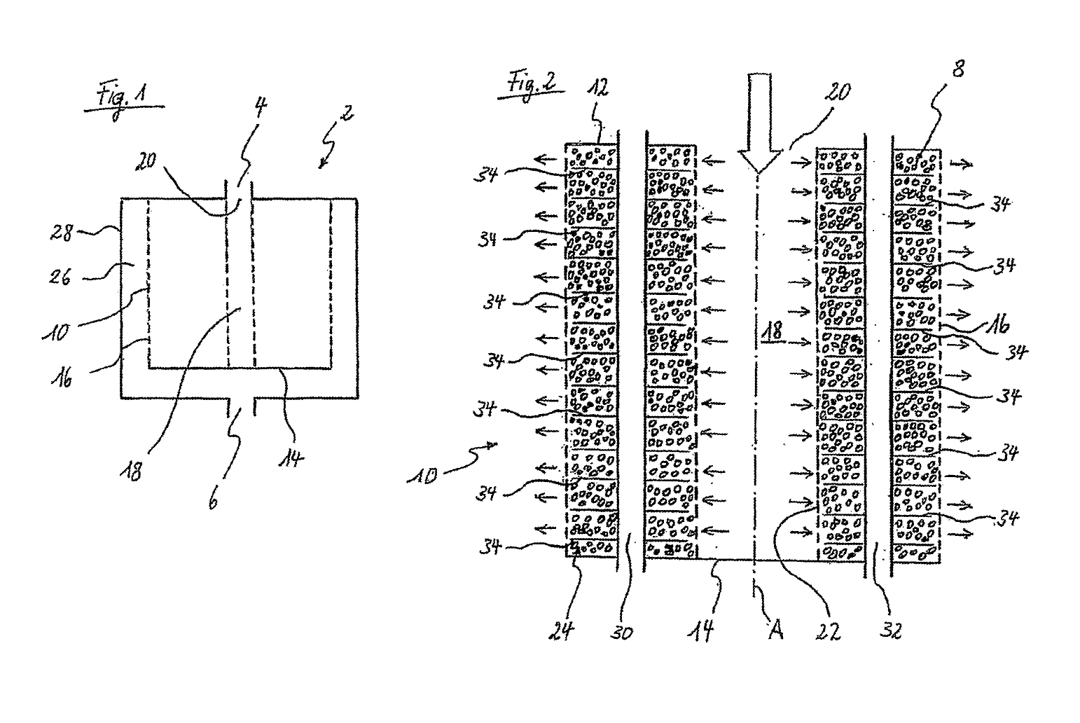

FIG. 1 shows in a basic representation an adsorption tank of a CO₂ binding unit, and

FIG. 2 shows in a basic representation an inner container disposed in an adsorption tank of a CO₂ binding unit and filled with a 002 binding agent.

The adsorption tank 2 of a CO₂ binding unit, which is represented in FIG. 1, is disposed at a suitable place in the pressure hull of a submarine, wherein, for reasons of better clarity, the representation of the submarine has been dispensed with. The adsorption tank 2 serves to bind CO₂ of a CO₂-containing gas mixture, which in the present case is constituted, above all, by the exhalation air, present in the pressure hull, of the crew of the submarine.

The adsorption tank 2 has a gas inlet 4 for the CO₂-containing gas mixture and a gas outlet 6 for the gas mixture or gas which in the adsorption tank 2 has been freed from the CO₂ . In the adsorption tank 2 is disposed an inner container 10 filled with a thermally regenerable CO2 binding agent 8.

The inner container 10 is of hollow-cylindrical configuration and is sealed in a gastight manner at its end faces 12 and 14, while a peripheral wall 16 of the inner container 10 is of gas-permeable configuration. Within the inner container 10 is configured a cylindrical duct 18, which extends concentrically to a center axis A of the inner container 10 in the longitudinal direction of the inner container 10 from its end face 12 through to its end face 14. Via an opening 20 configured on the end face 12, the duct 18 is line-connected to the gas inlet 4 of the adsorption tank 2. Like the peripheral wall 16 of the inner container 10, a wall 22 delimited the duct 18 is also of gas-permeable configuration. That end of the duct 18 which is facing away from the gas inlet 4 is sealed in a substantially gastight manner by the end face 14.

Together with the peripheral wall 16 of the inner container 10, the duct 18 forms an annular chamber 24, which is filled with the CO₂ binding agent 8. For the release of the CO2 present in the CO₂-containing gas mixture, the CO₂-containing gas mixture is led via the gas inlet 4 of the adsorption tank 2 into the duct 18 disposed therein. From there it flows through the gas-permeable wall 22 of the duct 18 into the annular chamber 24, where it comes into contact with the CO₂ binding agent 8, which binds the CO₂ contained in the gas. Freed from the CO₂, the gas mixture or gas leaves the inner container 10 via its gas-permeable peripheral wall 16 and flows into an annular chamber 26 which is configured in the adsorption tank 2 between the peripheral wall 16 of the inner container 10 and an outer wall 28 of the adsorption tank 2. The annular chamber 26 is fluidically connected to the gas outlet 6 of the adsorption tank 2, so that the purified gas mixture or gas can leave the adsorption tank 2 via the gas outlet 6.

In the CO₂ binding unit according to the invention, a thermally regenerable CO₂ binding agent 8 is used, i.e., for the regeneration of the CO₂ binding agent 8, heat must be supplied to this same. For this, a plurality of elongate heating elements 30 and 32 are provided. Oriented parallel to the center axis A of the inner container 10, said heating elements lead in the region of the annular chamber 24 through the inner container 10.

For the enlargement of their heat transfer surface, the two heating elements 30 and 32 are connected to 13 heating fins 34. The heating fins 34 are formed by comparatively thin annular flat disks made of a material having good thermal conductivity. The cross-sectional contour of the heating fins 34, which are arranged evenly distributed over that portion of the heating elements 30 and 32 which encroaches into the annular chamber 24, corresponds to the cross-sectional contour of the annular chamber 24. In order to ensure a good heat transfer from heating elements 30 and 32 to the heating fins 34, the heating elements 30 and 32 are connected to the heating fins 34 via a press fit or a soldered joint.

In particular, the heating fins 34 enable a high and uniform heat input into the annular chamber 24, filled with the CO₂ binding agent 8, of the inner container 10. As a result of this heat input, the CO₂ previously bound by the CO₂ binding agent 8 is released again from the CO2 binding agent 8, after which it can be extracted from the adsorption tank 2 via a pump (not represented in the drawing) connected to the gas inlet 4 of the adsorption tank 2.

### REFERENCE SYMBOL LIST

2—adsorption tank

4—gas inlet

6—gas outlet

8—CO₂ binding agent

10—inner container

12—end face

14—end face

16—peripheral wall

18—duct

20—opening

22—wall

24—annular chamber

26—annular chamber

28—outer wall

30—heating element

32—heating element

34—heating fin

A—center axis

1.-12. (canceled)

13. A submarine having a CO₂ binding unit disposed within the submarine for binding CO₂ of a CO₂-containing gas mixture, the CO₂ binding unit comprising at least one adsorption tank having a gas inlet, a gas outlet, and at least one inner container that is fillable with a CO₂ binding agent and that is gas-permeable at least in some regions, wherein the gas inlet is connected to a duct extending into an interior of the at least one inner container and the gas outlet is connected to a chamber in the at least one adsorption tank that externally surrounds the at least one inner container.

14. The submarine of claim 13 wherein the at least one inner container comprises an interchangeable cartridge.

15. The submarine of claim 13 further comprising at least one elongate heating element that extends through the at least one inner container and has a plurality of mutually spaced heating fins disposed on an outer side of the at least one elongate heating element.

16. The submarine of claim 15 wherein the at least one elongate heating element and the plurality of mutually spaced heating fins are disposed in the at least one inner container filled with the CO₂ binding agent such that the plurality of mutually spaced heating fins are embedded directly in the CO₂ binding agent.

17. The submarine of claim 15 wherein the at least one elongate heating element is oriented parallel to the duct.

18. The submarine of claim 15 wherein the plurality of mutually spaced heating fins fully surround the duct configured in the at least one inner container.

19. The submarine of claim 15 wherein the plurality of mutually spaced heating fins are oriented parallel to a direction of flow through the at least one inner container outside the duct.

20. The submarine of claim 15 wherein the at least one elongate heating element comprises a tube through which a heating medium flows.

21. The submarine of claim 15 wherein the at least one elongate heating element is part of an electrical resistance heating system.

22. The submarine of claim 13 wherein the at least one inner container of the at least one adsorption tank is cylindrically configured and is filled with the CO₂ binding agent, wherein the duct extends centrally in a longitudinal direction of the at least one inner container through an annular chamber between the duct and a peripheral wall of the at least one inner container.

23. The submarine as claimed in claim 22 wherein a plurality of mutually spaced heating fins disposed in the at least one inner container have a cross section that corresponds to an inner cross section of the annular chamber that is filled with the CO₂ binding agent.

24. The submarine as claimed in claim 23 wherein the plurality of mutually spaced heating fins comprise two apertures that diametrically oppose one another, wherein at least one heating element is disposed through the two apertures of the plurality of mutually spaced heating fins.

25. A CO₂ binding unit for binding CO₂ of a CO₂-containing gas mixture within a submarine, the CO₂ binding unit comprising an adsorption tank having a gas inlet, a gas CO₂ binding agent, wherein the gas inlet is connected to a duct extending into an interior of the inner container and the gas outlet is connected to a chamber in the adsorption tank that externally surrounds the inner container.

26. The CO₂ binding unit of claim 25 further comprising an elongate heating element that extends through the inner container and has a plurality of heating fins disposed on an outer side of the elongate heating element.

27. The CO₂ binding unit of claim 26 wherein the plurality of heating fins surround the duct within the inner container.

28. The CO₂ binding unit of claim 26 wherein cross sections of the plurality of heating fins correspond to an inner cross section of the inner container.
